(19) United States
(12) Patent Application Publication
(10) Pub. No.: US 2008/0030322 A1
(43) Pub. Date: Feb. 7, 2008

(54) GPS tool and equipment tracking system

(76) Inventors: John Henry Samuel Stauffer, (US); Crystal Hamilton, (US); Lorraine Gray, Rosemont, MN (US)

Correspondence Address: Patrick L. Mixon, 8732 Glencrest Lane, Dallas, TX, 75209, US

(21) Appl. No.: 11/498,494

(22) Filed: Aug. 4, 2006

(51) Int. Cl. G08B 1/00; G05B 19/00; G08B 1/08

(52) U.S. Cl. 340/539.2; 340/539.13; 340/5.2

(57) ABSTRACT

The GPS Tool and Tracking System is an invention that will allow owners of tools and equipment to track location of their inventories and reduce the likelihood of their thief and allow better control of inventories. The system will incorporate the use of GPS, Cell phone and Radio Frequency technologies to communicate the location a tool or piece of equipment. A central system will compile the locations and allow owners to log into a web-based system or a local system purchased under license to give a graphic display (see Attachment 1) of all the tools and equipment that have been linked to their account. Additional capabilities of the system will alert owners when tools have moved out of a predetermined geographical operating range. Depending on the design level purchased the owner will also be able to disable a tool or piece of equipment through the tracking system. Owners will also be able to print inventories of all their tools and equipment (see Attachment 2) to allow better control of billings tracking who, when and where the tools or equipment are being used.

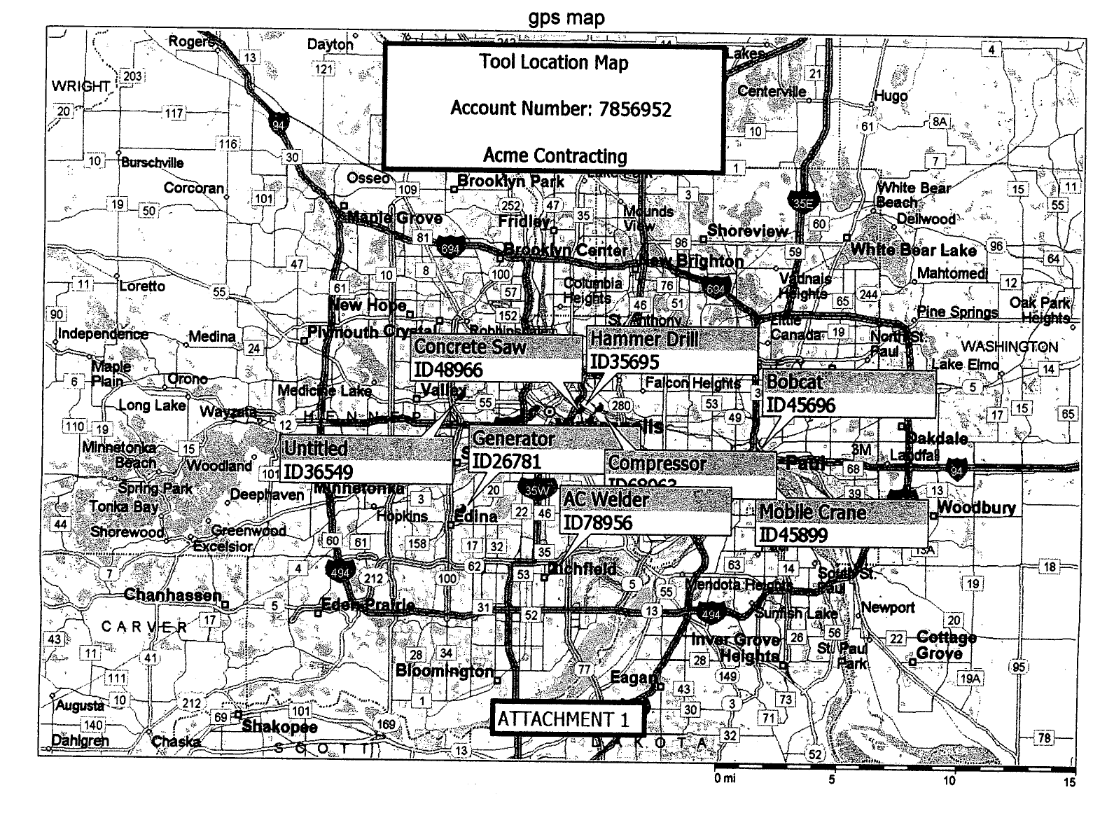

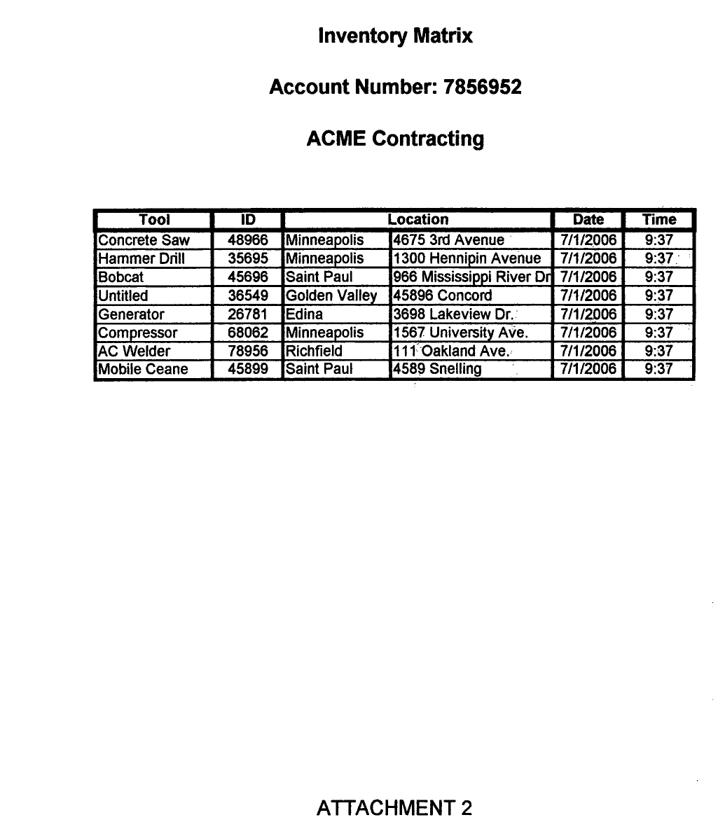

The tools and equipment will be required to have a locating device installed from the OEM or retrofitted. This device will be the base level design allowing owners only to track location. Higher level designs will include communication capabilities installed into the toll or equipments electrical system to disable the tool or equipments ability to start. At the highest design level, monitoring and communication with a tool or piece of equipments operating systems, i.e. oil pressure or level, cranes lifting loads etc.) will allow owners to identify maintenance needs or when users may have used a tool or piece of equipment outside their specified operating limits.

### BACKGROUND

1. Field of Invention

This invention relates to the tracking of tools and equipment through the use of an embedded GPS transmitter and/or receiver to determine location for theft protection or inventory control.

2. Description of Prior Art

Current use of GPS is relegated to use primarily for tracking position for navigational purposes. Other systems employ its use for tracking vehicles, and include systems for communication with the vehicle as used by General Motors On Star System. There are also systems used to track computers for theft prevention and retrieval.

The system described in this application is designed for use for preventing theft and facilitating the retrieval of tools or equipment where their owners have determined the value of the tool requires such measures. The system will include imbedded devices and for tracking location and communication to disable of tools and equipment that have been or have been moved outside a predetermined operating range. Owners can track location of tools and equipment by subscribing to a Web based service that will allow them to view current location of all tools and equipment linked to their ID. Additional applications can be integrated into the tools or equipment to allow for identification of maintenance needs or alerts when tools or equipment have been operated outside the manufacturers specifications. This would be accomplished by monitoring the tools and equipment systems and transmitting data for display to the owner.

For large-scale or rental fleet owners of tools and equipment the tracking software would be available under license to purchase for use at the owners site.

### OBJECTS AND ADVANTAGES

Accordingly, several objects and advantages of the GPS Tool and Equipment Tracking System are:

(a) Quickly determine location of tool through the Web Tracking System

(b) Ability to disable tool by the owner

(c) Allows the user owner to download inventory of all tools attached to their ID with location to assist in billing information

(d) Automatic reporting of tool movement to owner and/or security organization that a tool has been moved outside a prescribed operation range

Further objects and advantages are to provide and easy and reliable system for preventing theft by labeling tools that the system is installed and operational as a deterrent. Still further objects and advantages will become apparent from a consideration of the ensuing description and drawings.

### DRAWING FIGURES

The attached map and spreadsheet are shown to communicate the capability of the tool and equipment tracking software/service.

Attachment 1—The map displays how the tracking systems will display tool or equipment locations for a registered user. Each call-out indicates a tool or piece of equipment linked to the registered user. The call-out can be expanded to indicate exact location by GPS coordinates or address.

Attachment 2—The spreadsheet depicts how a registered user would be able to have access to their complete inventory of tools and equipment whenever they have logged into the system

### SUMMARY

In accordance with this invention of a GPS Tool and Equipment Tracking System comprises an embedded GPS for tracking tools and equipment for the basic design, but can include communication capabilities that will have the ability to disable a tool or piece of equipment at the higher level design. Both designs can be linked to a Web based system to allow the owners to access location information of the tools and equipment linked to their ID.

### OPERATION

The manner of using the GPS Tool and Equipment Tracking System requires that the tool or equipment have embedded in the housing the object of this patent application a GPS transmitter embedded in the housing of the tool. This is considered the base design of the system in hat it will allow tracking of the tool only. The higher level design includes embedded communication devices linked to the electronic circuitry of the tool or equipment that would enable a bit that would prevent operation.

Other technologies that will be incorporated in other levels of design will be Cell Phone and Radio Frequency Systems to allow tracking in areas where GPS communication may not be available.

Upon purchase or retrofitting of a tool or piece of equipment with the GPS Tool and Equipment Tracking System an owner would be required to register the device and link it to their account. Once registered, the owner will be able to view the location of all tools and equipment registered under their ID in real time. Owners that have purchased tools with the high level design with the communication capability will also have the capability to disable tools or equipment that are determined to be outside the operational range they have been assigned.

### CONCLUSION, RAMIFICATIONS AND SCOPE

Accordingly, the reader will see that the GPS Tool and Equipment Tracking System will allow the owners of tools and equipment to ability to monitor location, track inventories and disable tools and equipment to lower tool and equipment replacement costs, lower insurance rates and better manage operations.

Although the description above contains much specificity, these should not be construed as limiting the scope of the invention but merely providing illustrations of some of the presently preferred embodiments of this invention. For example, this invention can be used to track any object that the owner may determine it's needed.

I claim:

1. A method for the tracking tools and equipment through the use of a GPS Tool and Equipment Tracking System:
(a) providing a means to locate all tools and equipment by owner
(b) providing a means for disabling tools and equipment in unauthorized locations
(c) providing a means to control tool inventories and billing
(d) capability of retrofitting locating devices on tools or equipment
